(19) United States
(12) Patent Application Publication
(10) Pub. No.: US 2005/0194313 A1
(43) Pub. Date: Sep. 8, 2005

(54) Method and apparatus for energy efficient high pressure extraction

(76) Inventors: Lalit Chordia, Pittsburgh, PA (US); Jose Martinez, Gibsonia, PA (US)

Correspondence Address: MEYER UNKOVIC & SCOTT LLP, 1300 OLIVER BUILDING, PITTSBURGH, PA, 15222, US

(21) Appl. No.: 11/026,579

(22) Filed: Dec. 30, 2004

Related U.S. Application Data
(60) Provisional application No. 60/533,686, filed on Dec. 31, 2003.

(51) Int. Cl. B01D 11/00

(52) U.S. Cl. 210/634; 210/774; 210/805; 210/806

(57) ABSTRACT

The present invention provides a method and apparatus for the recovery of desired substances from a feed material having a given solubility in carbon dioxide. The present invention also provides a means for increasing energy efficiency in the recovery of desired substances by adding a compressor into the recovery process, as well as using tap water to cool the extraction fluid. The present invention also provides a means for energy reduction in high pressure recycling by replacing the expansion valve with a turbine. The present invention also provides a means of energetically coupling the turbine to the pump.

### CROSS-REFERENCE TO RELATED APPLICATION

This patent application claims priority from the United States provisional patent application of the same title, which was filed on Dec. 31, 2003 and assigned U.S. patent application Ser. No. 60/533,686.

### BACKGROUND OF THE INVENTION

Supercritical fluids have found great utility in a variety of areas over the past few decades. A key goal of researchers has been to find applications in which supercritical fluids can replace conventional organic solvents, which can be toxic and flammable. One such process is the extraction of desirable substances such as oils, aromas and antioxidants. Usually, a solvent such as hexane extracts the substance but the issue remains of removing the solvent from the extracted product. This step in the process can be very costly, in addition to the fact that the solvent may extract some other undesirable substances along with the target product. If this happens, then additional separation steps need to be implemented as well.

A supercritical fluid is unique in that its density can be manipulated by simply changing the pressure or temperature. In turn, all density-dependent properties are also varied. This makes supercritical fluids ideal candidates for extraction solvents. At a given set of conditions, a desired substance can be solubilized and extracted in the supercritical fluid. Once extracted, the extracted product can be separated from the supercritical fluid simply by changing the density through pressure relief and/or modifying the temperature. No further separation steps are necessary. Carbon dioxide is a popular supercritical fluid choice due to the fact that it is nontoxic, nonflammable, and inexpensive.

The concept of using supercritical fluids for extraction has been heavily researched and many patents have been published on this topic. Several examples include U.S. Pat. Nos. 4,466,923, 4,675,133, 4,770,780, 4,877,530, 5,932,101, 6,106,720, and U.S. Ser. No. 2002/0158015. However, none of these include recycling the supercritical fluid. There are some patents, though, that do refer to this idea. U.S. Pat. No. 5,210,240 discusses the extraction of oils from oil-containing solid vegetable material with a mixture of a supercritical fluid and an entraining agent. Once the oil is extracted, the single phase mixture is separated in a separator into an oil-rich liquid phase and an oil-exhausted gaseous phase. The gaseous phase can then be reconverted into a supercritical fluid and recycled. U.S. Pat. No. 6,358,301 discloses extracting an oil from a crude oil product using a supercritical fluid. The supercritical fluid with the dissolved oil then passes over a fixed bed adsorber that leads to obtaining an adsorbent loaded with the desired oil and a pure supercritical fluid. The supercritical fluid is then recycled back to the extraction device.

In supercritical fluid extraction, recycling is usually performed at low pressure, which refers to the pressure at which the desired substance is separated in a cyclone from the extraction fluid. Typically, because the solvent is recycled in the liquid state, a chiller unit is employed in order to cool down and condense the extraction fluid before it enters the pump. However, this requires large amounts of water and refrigerant which in turn, greatly increase the energy requirements. Lack (1985; Kriterien zur Auslegung von Anlagen fur die Hochdruckextraktion von Naturstoffen; dissertation) presented an alternative configuration in which the pump is replaced by a compressor after the separation step. The authors demonstrated that at extraction pressures below 300 bar replacing the pump with the compressor resulted in energy savings. However, at extraction pressures above 300 bar, the pump system was still more efficient. The present invention addresses the issue of increasing the energy efficiency of systems where the pump is utilized by adding a compressor into the system after separation of the extracted component. With this implementation, two advantages can be realized. The first is that instead of using a chiller, the extraction fluid can be cooled down with room temperature tap water from a cooling tower. Second, the mechanical energy required of the pump will be lowered. The combination of these allows for reductions in energy requirements and thus, lower process costs.

Recycling can be performed at high pressures as well, making it different from the standard extraction process, namely in terms of the energy required. High pressure recycling is carried out when the solubility of the desired substance in the extraction fluid is low, typically less than 0.5%. When the solubility of the desired substance in the extraction fluid is high, not all of the desired substance is removed from the extraction fluid at the separation stage. Therefore, when the extraction fluid is recycled back for another cycle, there is already some desired substance contained in the extraction fluid, which in turn increases the number of cycles required to remove all of the desired substance and ultimately leads to longer extraction times. In order to overcome this obstacle, the extraction fluid is expanded and then heated to a gaseous state before separation of the desired substance from the extraction fluid. In a gaseous state, the desired substance will have negligible solubility in the extraction fluid. The extraction fluid is then recycled in a low pressure state. If the solubility of the desired substance in the extraction fluid is low, conversion to a gaseous state is not required before separation. With the extraction fluid still in a supercritical state high pressure recycling can be employed. Eggers et al. (1985) JAOCS 62(8) 1222-1230 published theoretical work concerning the high pressure extraction of oil-rich seeds compared to conventional hexane extraction. The authors were able to conclude that high pressure recycling using an expansion valve did compare favorably with hexane extraction energetically. Eggers et al also refer to this concept in U.S. Pat. No. 4675133. Yoo and Hong in “Modeling of the Supercritical Fluid Extraction of Oilseeds” 132-154 also discuss the importance of operational energy costs on the overall economics of the process for the supercritical fluid extraction of oilseeds for a large-scale plant. The present invention discloses a method for increasing energy efficiency in high pressure recycling by replacing the expansion valve with a turbine. Extraction pressures and solubility requirements greatly influence process parameters and what types of recycling processes are feasible to perform.

### BRIEF SUMMARY OF THE INVENTION

The present invention provides a method for energy efficient extraction of desired substances from a feed material comprising the steps of: extracting at least one desired substance in carbon dioxide at a desired pressure greater than 300 bar and a desired temperature using supercritical carbon dioxide, creating a mixture; expanding the mixture to a two-phase region; heating the mixture to convert the carbon dioxide to a vapor state; separating the desired substance from the carbon dioxide; compressing the carbon dioxide to a higher pressure supercritical state; cooling the carbon dioxide to a liquid state; pumping the carbon dioxide back to the desired extraction pressure; and adjusting the carbon dioxide to the desired extraction temperature.

The present invention also provides for an apparatus for energy efficient extraction of desired substances from a feed material comprising: an extraction vessel for extracting at least one desired substance having solubility in carbon dioxide at a desired pressure greater than 300 bar and a desired temperature using supercritical carbon dioxide, creating a mixture; an expansion mechanism for expanding the mixture to a two-phase region; a heat exchanger for heating the mixture to convert the carbon dioxide to a vapor state; a separating means for separating the substance from the carbon dioxide; a compressor for compressing the carbon dioxide to a higher pressure supercritical state; a heat exchanger for cooling the carbon dioxide to a liquid state that employs water from a cooling tower; a pump for pumping the carbon dioxide back to the desired extraction pressure; and a heat exchanger for adjusting the carbon dioxide to the desired extraction temperature.

The present invention also provides for a method for energy efficient extraction of desired substances from a feed material comprising the steps of: extracting at least one desired substance in carbon dioxide at a desired pressure and temperature using supercritical carbon dioxide, creating a mixture; expanding the mixture through a turbine; separating the desired substance from the carbon dioxide; cooling the carbon dioxide to a liquid state; pumping the carbon dioxide with a pump back to the desired extraction pressure; and adjusting the carbon dioxide to the desired extraction temperature.

The present invention also provides for an apparatus for energy efficient extraction of desired substances from a feed material comprising: an extraction vessel for extracting at least one desired substance having solubility in carbon dioxide at a desired pressure and temperature using supercritical carbon dioxide, creating a mixture; a turbine for expanding the mixture; a separating means for separating the desired substance from the carbon dioxide; a heat exchanger for cooling the carbon dioxide to a liquid state; a pump for pumping the carbon dioxide to the desired extraction pressure; and a heat exchanger for adjusting the carbon dioxide to the desired extraction temperature.

### BRIEF DESCRIPTION OF THE DRAWINGS

For the present invention to be easily understood and readily practiced, the invention will now be described, for the purposes of illustration and not limitation, in conjunction with the following figures, wherein:

FIG. 1 is a schematic representation of a traditional supercritical fluid extraction process using low pressure recycling;

FIG. 2 is a schematic representation of one embodiment of the present invention for supercritical fluid extraction in which a compressor is added after the separation step in order to return the extraction fluid to a high pressure state; and

FIG. 3 is a schematic representation of another embodiment of the present invention for high pressure recycling in a supercritical fluid extraction process in which a traditional expansion mechanism, the back pressure regulator, is replaced with a turbine.

### DETAILED DESCRIPTION OF THE INVENTION

The process parameters for supercritical fluid extraction are dictated by several important parameters, including the solubility of the desired substance in the supercritical fluid, which serves as the extraction fluid. Solubility is a continuum based on pressure and temperature, among other factors. It is important at at least two different points in the extraction process: 1) while the desired substance is being extracted from the starting material by the extraction fluid and 2) when the desired substance is being separated from the extraction fluid. When recycling the extraction fluid to make the extraction cycle more energy efficient, the process parameters are determined by the solubility of the desired substance in the extraction fluid at separation. If the solubility of the desired substance is high at separation, typically greater than 0.5%, then recycling of the extraction fluid needs to be performed at low pressure. Otherwise, too much of the desired substance remains entrained in the extraction fluid. In the case of low pressure recycling, another important process parameter is the extraction pressure. If the extraction pressure is greater than 300 bar, then use of a pump to adjust the pressure of the extraction fluid before it is returned to the extraction vessel is typically more beneficial. However, at extraction pressures of less than 300 bar, use of a compressor in place of the pump is typically more advantageous. If the solubility of the desired substance is less than 0.5% at separation, recycling can take place at high pressure. The present invention provides improvements to the current processes of high pressure recycling and low pressure recycling.

One embodiment of the present invention provides a method and another embodiment of the present invention provides an apparatus for supercritical fluid extraction of a desired substance at a desired extraction temperature and pressure in which a compressor is added to the traditional extraction system with low pressure recycling that utilizes a pump after separation of the desired substance and extraction fluid in a separating means. Therefore, in the apparatus of the present invention, the system contains both a pump and a compressor. The desired substance includes, but is not limited to, fats and oils. The desired extraction pressure and temperature are defined as conditions which allow for the desired substance to be extracted into the extraction fluid. By using a compressor in the apparatus to compress the extraction fluid to a higher pressure from what it was originally expanded to after extraction and cooling the extraction fluid with room temperature tap water from a cooling tower, the energy requirements for the process, and consequently the cost, are lower than when traditional low pressure recycling is utilized. The present invention can be employed to the extraction of various types of desired substances, in situations where the solubility of the desired substance in the extraction fluid at the time of separation is greater than 0.5% and the extraction pressure is greater than 300 bar.

In other embodiments of the present invention, if the solubility of the desired substance in the extraction fluid is less than 0.5% at the time of separation, the extraction fluid is then maintained at a high pressure after both extraction and separation. Therefore, the need for the compressor in the system is eliminated and recycling can be performed at high pressure. In another embodiment of the present invention, additional energy savings can be realized by replacing the expansion valve, such as a back pressure regulator, that is used after extraction to reduce the pressure with a turbine in the apparatus. The feed material preferably has solubility in carbon dioxide lower than 0.1%. In some embodiments of the apparatus of the present invention, expansion may be performed with a turbine and the turbine may be energetically coupled to the pump.

The method and apparatus of various embodiments of the present invention may utilize a continuous or semi-continuous process. In one embodiment of the present invention, supercritical carbon dioxide is used as the extraction fluid. In some embodiments of the present invention, the extraction fluid is cooled using cooling water.

The following figures demonstrate the method of the present invention and the pieces of equipment that are required for the apparatus of the present invention.

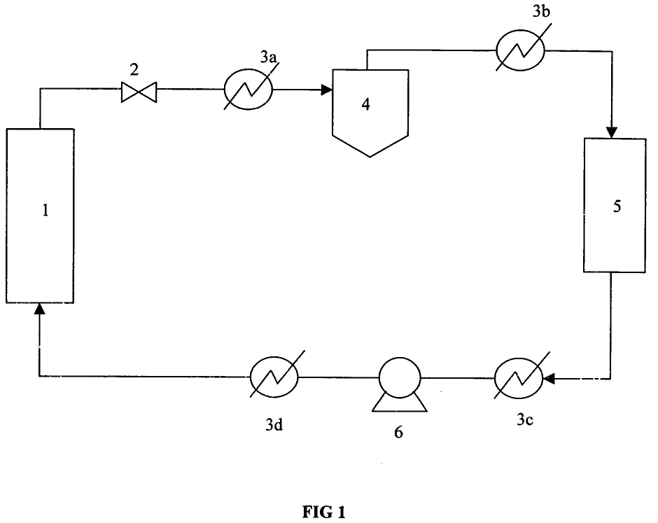

FIG. 1 illustrates a traditional supercritical fluid extraction in which recycling is performed at low pressure, which refers to the pressure at which the desired substance is separated in a cyclone from the extraction fluid. The need to recycle at low pressure is dictated by the solubility of the desired substance in the extraction fluid at the time of separation. If it is greater than 0.5%, then low pressure recycling needs to be performed. The desired substance is first extracted in the extraction vessel 1 with the extraction fluid. The extraction fluid, with the desired substance dissolved in it, passes through a back pressure regulator 2, which serves as the expansion mechanism for the process, where the pressure is relieved to the two-phase region. The mixture is then heated by a heat exchanger 3a in order to convert the extraction fluid to a vapor phase. Next, in the cyclone 4, the desired substance is separated from the extraction fluid. The extraction fluid is then cooled in another heat exchanger 3b before being sent to a receiver 5. Upon leaving the receiver 5, the extraction fluid is further cooled in a heat exchanger 3c in order to ensure that it is in a liquid state before being sent to a pump 6. The pump 6 and another heat exchanger 3d return the extraction fluid back to the original extraction conditions before it is recycled back to the extraction vessel 1. In this conventional process, the separation is carried out at a pressure low enough so that the extraction fluid is no longer supercritical in nature.

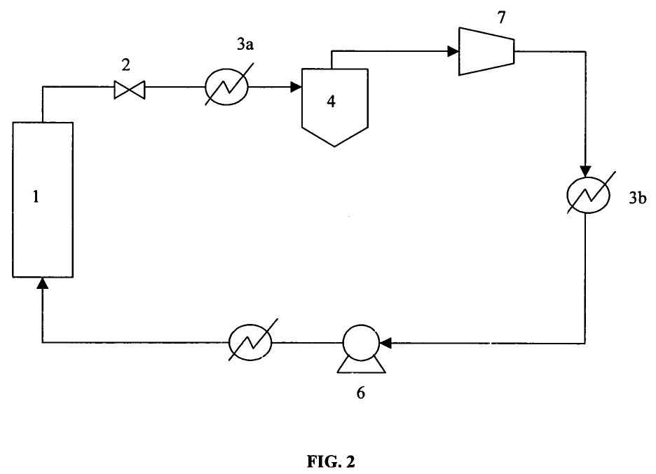

FIG. 2 illustrates one embodiment of the present invention in which a compressor is added to a system of supercritical fluid extraction and recycling. The desired substance is first extracted in the extraction vessel 1 with the extraction fluid. The extraction fluid, with the desired substance dissolved in it, passes through a back pressure regulator 2 where the pressure is relieved to the two-phase region. The mixture is then heated by a heat exchanger 3a in order to convert the extraction fluid to a vapor phase. Next, in the cyclone 4, the desired substance is separated from the extraction fluid and subsequently removed. The extraction fluid is then compressed back to high pressure in a compressor 7. Upon leaving the compressor 7, the extraction fluid is then sent directly to a heat exchanger 3b to be cooled with tap water from a cooling tower before entering a pump 6. The pump 6 and another heat exchanger 3c return the extraction fluid back to the original extraction conditions before it is recycled back to the extraction vessel 1.

By adding a compressor to the extraction system, the process becomes more energy efficient when compared to the traditional process of supercritical fluid extraction with low pressure recycling. In the traditional low pressure recycling system, only a pump is employed. However, the present invention uses both a pump and a compressor to increase the energy efficiency of the process. The following table demonstrates that at a variety of extraction conditions, recycling with the addition of a compressor, along with tap water from a cooling tower for cooling the extraction fluid reduces the required process energy.

TABLE 1
Energy Reduction Realized by Adding a
Compressor to the Extraction Process

| | | | | | | |
|---|---|---|---|---|---|---|
| P (bar) | 600 | 600 | 350 | 350 | 100* | 100* |
| T (° C.) | 80 | 40 | 40 | 80 | 80 | 40 |
| Energy | 63% | 51% | 57% | 65% | 95% | 81% |
| Reduction | | | | | | |

*Only a compressor is utilized; no pump is required

As reflected in the table, the energy requirements for recycling with the addition of a compressor are significant. The reduction in energy is a result of a combination of lower process energy requirements, as well as lowered utility requirements from replacing a conventional chiller unit with tap water from a cooling tower. These energy savings will in turn be reflected in the cost of the process. However, when certain solubility requirements are met, this process can be replaced by high pressure recycling, which results in additional energy savings. These savings in energy can be more significant when a turbine is used as the expansion mechanism instead of the back pressure regulator. Further improvements can be made when the turbine is coupled to the pump.

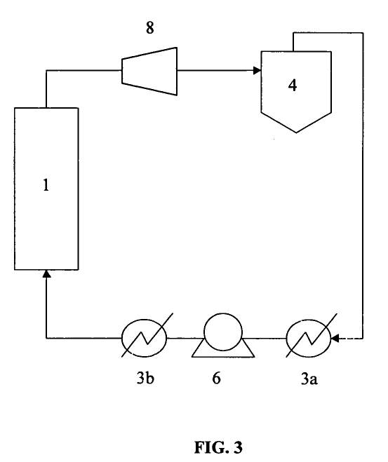

FIG. 3 illustrates another embodiment of a supercritical fluid extraction process using high pressure recycling where the expansion valve is replaced with a turbine. The desired substance is first extracted in the extraction vessel 1 with the extraction fluid. The extraction fluid, with the desired substance dissolved in it, passes through a turbine 8 where the pressure is relieved to a lower pressure but still keeps the extraction fluid in the supercritical state. Next, in the cyclone 4, the desired substance is separated from the extraction fluid and subsequently removed. The extraction fluid is cooled with tap water from a cooling tower in a heat exchanger 3a before entering a pump 6. The pump 6 and another heat exchanger 3b return the extraction fluid back to the original extraction conditions before it is recycled back to the extraction vessel 1. In another embodiment, the turbine 8 is energetically coupled to the pump 6. Replacement of the back pressure regulator, which serves as the expansion mechanism, with a turbine and energetically coupling it to the pump results in the following energy savings, as shown in Table 2.

TABLE 2
Energy Reduction in High Pressure Recycling Realized
by Replacing the Expansion Valve with a Turbine and
Energetically Coupling the Turbine to the Pump

| | | | | | | |
|---|---|---|---|---|---|---|
| P (bar) | 600 | 600 | 350 | 350 | 100 | 100 |
| T(C.) | 80 | 40 | 40 | 80 | 80 | 40 |
| Energy | 57% | 61% | 59% | 35% | 1.7% | 2.3% |
| Reduction | | | | | | |

As can be seen from Table 2, replacing the expansion valve with a turbine, which is then subsequently coupled to a pump, increases energy efficiency in high pressure recycling, except at low pressures. Once again, these energy savings will be reflected in the overall cost of the process.

The following example clearly illustrates how the comparisons were made between the energy requirements for the traditional process that uses low pressure recycling due to the solubility of the desired substance in the extraction fluid at the time of separation being greater than 0.5% and the present invention in which a compressor is added to the system.

### EXAMPLE 1

Conditions: Extraction Pressure =600 bar; Extraction Temperature =80° C.

In traditional supercritical fluid extraction with carbon dioxide at the conditions stated above, once the mixture undergoes expansion and heating, the desired substance is separated from the carbon dioxide. At this point the pressure and temperature of the carbon dioxide are 67 bar and 28° C., respectively. The carbon dioxide is then typically cooled to 15° C. using a chiller unit, which requires a large amount of energy. The carbon dioxide, now in a liquid state, is pumped back to the desired extraction pressure and finally, temperature is adjusted in a heat exchanger to the desired extraction temperature.

According to the process described in the present invention, once the desired substance is separated from the carbon dioxide, the carbon dioxide is then compressed to 100 bar, which leads to a corresponding temperature of 53° C. Next, a cooling tower is used to cool the carbon dioxide to 27° C. The energy required for this cooling step is more than 90% less than that for the chiller unit in the traditional process. The carbon dioxide, now in a liquid state, is then pumped back to the desired extraction pressure and finally, the temperature is adjusted in a heat exchanger to the desired extraction temperature.

The difference in the cooling steps for the two processes results in a substantial overall energy reduction for the method described in the present invention. Additionally, the heating requirements are 30% lower than for the traditional process. Differences such as these are reflected at various other extraction pressure and temperature combinations, as shown in Table 1.

The details of the invention mentioned previously can also be applied to the apparatus as well.

1. A method for energy efficient extraction of desired substances from a feed material comprising the steps of:
a) extracting at least one desired substance in carbon dioxide at a desired pressure greater than 300 bar and a desired temperature using supercritical carbon dioxide, creating a mixture;
b) expanding said mixture to a two-phase region;
c) heating said mixture to convert the carbon dioxide to a vapor state;
d) separating said desired substance from said carbon dioxide;
e) compressing said carbon dioxide to a higher pressure supercritical state;
f) cooling said carbon dioxide to a liquid state;
g) pumping said carbon dioxide back to said desired extraction pressure; and
h) adjusting said carbon dioxide to said desired extraction temperature.

2. The method of claim 1, wherein the process is continuous.

3. The method of claim 1, wherein the process is semi-continuous.

4. The method of claim 1, wherein said carbon dioxide is cooled using cooling water.

5. A method for energy efficient extraction of desired substances from a feed material comprising the steps of:
a) extracting at least one desired substance in carbon dioxide at a desired pressure and temperature using supercritical carbon dioxide, creating a mixture;
b) expanding said mixture through a turbine;
c) separating said desired substance from said carbon dioxide;
d) cooling said carbon dioxide to a liquid state;
e) pumping said carbon dioxide with a pump back to said desired extraction pressure; and
f) adjusting said carbon dioxide to said desired extraction temperature,

6. The method of claim 5, wherein said turbine is energetically coupled to said pump.

7. The method of claim 5, wherein the process is continuous.

8. The method of claim 5, wherein the process is semi-continuous.

9. An apparatus for energy efficient extraction of desired substances from a feed material comprising:
a) an extraction vessel for extracting at least one desired substance having solubility in carbon dioxide at a desired pressure greater than 300 bar and a desired temperature using supercritical carbon dioxide, creating a mixture;
b) an expansion mechanism for expanding said mixture to a two-phase region;
c) a heat exchanger for heating said mixture to convert said carbon dioxide to a vapor state;
d) a separating means for separating said desired substance from said carbon dioxide;
e) a compressor for compressing said carbon dioxide to a higher pressure supercritical state;
f) a heat exchanger for cooling said carbon dioxide to a liquid state that employs water from a cooling tower;
g) a pump for pumping said carbon dioxide back to said desired extraction pressure; and
h) a heat exchanger for adjusting said carbon dioxide to said desired extraction temperature,

10. An apparatus for energy efficient extraction of desired substances from a feed material comprising:
a) an extraction vessel for extracting at least one desired substance having solubility in carbon dioxide at a desired pressure and temperature using supercritical carbon dioxide, creating a mixture;
b) a turbine for expanding said mixture;
c) a separating means for separating said desired substance from said carbon dioxide;
d) a heat exchanger for cooling said carbon dioxide to a liquid state;
e) a pump for pumping said carbon dioxide back to said desired extraction pressure; and
f) a heat exchanger for adjusting said carbon dioxide to said desired extraction temperature,

11. The apparatus of claim 10, wherein said turbine is energetically coupled to said pump.
